(19) United States
(12) Patent Application Publication
(10) Pub. No.: US 2007/0084335 A1
(43) Pub. Date: Apr. 19, 2007

(54) Musical instrument with bone conduction monitor

(76) Inventor: John Warwick Silzel, Yorba Linda, CA (US)

Correspondence Address: John W. Silzel, 19741 Venecia Lane, Yorba Linda, CA, 92886, US

(21) Appl. No.: 11/580,427

(22) Filed: Oct. 13, 2006

Related U.S. Application Data
(60) Provisional application No. 60/726,630, filed on Oct. 14, 2005.

(51) Int. Cl. G10H 3/00

(52) U.S. Cl. 84/723

(57) ABSTRACT

The invented device enables the player of a musical instrument to monitor an electrical audio signal by bone conduction during playing. A conductively emitting surface, comprising an electromechanical transducer driven by the electrical audio signal to be monitored, is disposed on the exterior of the musical instrument to contact a conductively receptive exterior surface of the player's body near a bony structure of the player's head. In the most preferred embodiment, the musical instrument is a chin-supported stringed instrument, the instrument chinrest comprises the conductively emitting surface, and the conductively receptive exterior body surface is skin overlying the player's mandible. Acoustic energy produced by the electromechanical transducers is conducted from the conductively emitting surface to bones of the head, causing perception of the audio information contained in the electrical audio signal. The device provides simple, sanitary, discreet, and private monitoring of useful signals during performance, recording, or practicing.

### CROSS-REFERENCE TO RELATED APPLICATIONS

This application is entitled to the benefit of Provisional Patent Application Ser. No. #60/726630, “Lightweight Chin-Supported Stringed Musical Instrument and Transducer”, filed Oct. 14, 2005.

### STATEMENT REGARDING FEDERALLY SPONSORED RESEARCH OR DEVELOPMENT

This invention was not made under, or in connection with, any federally sponsored research or development program.

### SEQUENCE LISTING, TABLE OR COMPUTER PROGRAM LISTING

Not Applicable

### BACKGROUND OF THE INVENTION

This invention relates to musical instruments, specifically to an improved instrument monitoring device.

There have been many inventions aimed at the electronic amplification of the violin. Most of these have been successful in providing greater loudness. The artistic evolution in amplification of bowed string instruments is still ongoing, in part because the amplified instruments currently available do not yet offer the refined response, playability, light weight, and sound quality that players desire. In fact, the advances in instrument amplification have themselves created new difficulties for many musicians. A significant problem for players of amplified instruments is that despite the increased loudness afforded by amplification, ironically it is often difficult in live performance to adequately hear one's own instrument at all times so as to monitor tone and pitch, particularly when playing quiet backup passages in support of louder soloists.

The underlying problem in instrument monitoring systems is that of maintaining an acoustic interface between the instrument and player. This problem arises because a satisfactory acoustic interface is not simply the result of providing sufficient loudness. Rather the quality of the interface depends upon the presence of certain critical frequency and timing information in the monitored signal. The problem of monitoring is particularly severe for players of bowed string instruments because bowed string instruments often do not have frets, and therefore require the performer to be able to hear and adjust the musical pitch of each note continuously during performance.

The amount of bow pressure applied to the bowed string, and the speed of motion of the bow, must also be evaluated and adjusted continuously based on the player's perception and assessment of the tone being produced by the instrument at any given moment. The player of a bowed amplified string instrument therefore has an exceptional need for high-quality, real time monitoring of each individual note played in order to employ the largely unconscious skills that lead to pitch and bow pressure adjustments during performance.

A further and very significant problem for players of amplified bowed string instruments is that they are unconsciously accustomed to obtaining most of this bow pressure monitoring feedback, as well as important feedback related to rhythmic accuracy and maintenance of left-to-right hand synchronization, from cues provided by the complex properties of wooden, non-amplified acoustic violins. The player of a conventional wooden acoustic violin or viola in fact hears a different range of frequencies when listening to her own playing than does her audience located even a few feet away from the instrument being played. This “near field” sound heard by the player results from an increased proportion of acoustic transients in the range from 9 to more than 40 kilohertz which, because of their high frequency, are rapidly attenuated by passage through even a few feet of air. The player's ears, and particularly the left ear, are close enough to the instrument to detect these air conducted transients, while the more distant audience or microphone perceives them to a much lesser extent because of attenuation. This is desirable, because the transients useful to the player are often described as “harsh” or “scratchy” by listeners not accustomed to the near field sound of the instrument. The traditional acoustic, un-amplified instruments of the violin family therefore advantageously provide two different sounds: a near field sound useful to the player; and a far field sound more pleasurable and familiar to the audience. However, amplified bowed instruments of the prior art either fail to provide these advantageous separate near and far field sounds, or do so with an unacceptably high susceptibility to microphonics, which is discussed below.

Electric bowed instruments are usually modified from their traditional acoustic form for amplified playing. For example, an instrument having a “sounding board” or other radiating structure that causes the instrument itself to radiate sound directly into the air, as is the design intent of an acoustic instrument, is generally unsatisfactory for amplified playing. This is so because the sound radiation process can also operate in reverse: sound from the stage environment, including other instruments, voices, or even handling of the instrument itself, can induce movement of the radiating structure, which can be detected by the instrument's pickup and amplified. The instrument then undesirably acts as a microphone, and the resulting microphonic signals, or microphonics, cause undesirable feedback in the amplifier/speaker/instrument system, introduce unwanted noise, and contribute to poor channel isolation during performance or recording.

The most obvious way to reduce microphonic susceptibility is to fabricate the instrument body from a solid material, such as wood, to increase the vibrating mass. These “solid body” construction methods, commonly used with electric guitars, have been applied to amplified instruments in the violin family, with unsatisfactory results. While the extra weight of an electric guitar can be borne by a strap over the player's shoulders, the violinist or violist must support the extra weight by increased pressure with her chin and shoulder. Amplified instruments that are heavy require more chin pressure for support compared to non-amplified acoustic instruments, and so are more likely to contribute to fatigue and overuse injuries in musicians, or to force the player to compromise her playing technique by supporting the instrument with the left hand, rather than the chin, during performance. The problem is so significant as to have inspired an invention for supporting amplified violin-like instruments by means of straps and/or extensions of the instrument body, rather than by the player's chin (Wood, U.S. Pat. No. 5,528,971, incorporated by reference). However, this invention is also unsatisfactory in many situations: neck straps may prevent the player from being free to rapidly remove the instrument from the shoulder during a rest in the music or on-stage maneuvers such as clapping or dancing; and the appearance of such a support system is highly unconventional and unsuitable to some playing situations.

Efforts to reduce microphonics have resulted in many modifications to instruments for amplified playing, including the use of solid bodies, semi-solid bodies, minimal bodies, foam dampening inserts, or other changes to the traditional acoustic instrument designs. An inevitable result of these modifications is that, in the absence of an amplification system, the volume of sound these modified instruments radiate directly to the air is greatly reduced in comparison to unmodified acoustic instruments. Consequently, the player of a modified instrument must usually monitor her playing utilizing the amplified pickup signal, by means of a speaker or headphone, rather than utilizing the near-field sound radiated directly from the instrument itself.

Two problems result from the player's dependence on the amplified pickup signal for monitoring purposes. Firstly, the pickup systems used on bowed amplified instruments are deliberately designed to approximate, in their electronic output, the far-field sound desirable to the audience, so that the output of the pickups attenuate the “scratchy” near-field cues useful to the player. Indeed, many inventions related to amplified bowed instruments contribute to the monitoring problem by intentionally removing these “noise” artifacts which are actually useful to the player (McClish, U.S. Pat. No. 4,884,486, which is incorporated by reference). Players readily accept the removal of the artifacts because they are unaware of their value and because they themselves enjoy the far-field sound of the instrument, to which they have become accustomed by listening to recordings. Secondly, because the high frequency near-field cues that do remain in the pickup signal often approach the limits of the monitoring system's frequency response, the near-field cues are often reproduced inadequately, and, if speakers are used for monitoring, further attenuated by passage through the air from the monitor speakers to the player's ear.

Bowed instrument players perceive and utilize these critical high frequency cues unconsciously, by skills developed over years of practice. Because players are usually unaware that these cues exist and unconscious of how they are used by their brains during playing, they are unaware in most cases of the cause of their dissatisfaction with the sensory feedback from their amplified bowed instruments during performance, being able to state only “I cannot hear myself”. In frustration, many players resort to increasing the volume of their monitoring system, hoping to hear their performance more clearly. But because the critical high frequency cues are unavailable from ordinary amplified bowed instruments, and inadequately reproduced by ordinary monitoring equipment, increased amplification merely boosts frequencies devoid of these cues and introduces distortion, which further degrades pitch recognition, and leads to high sound pressure levels which over time can damage the player's hearing permanently.

Two other practical problems of complexity and mobility are introduced by conventional monitoring systems. The player of a bowed amplified musical instrument already finds himself tied by a cable or wireless system to his amplification system. When a monitor is added, he must remain near his monitor speakers if he is to be able to monitor his playing. Alternative monitoring systems using earphones or earpieces afford greater mobility but add either another wire or cable connection between the player and his equipment or another costly wireless link that must be maintained during performance. There is therefore a significant need for bowed amplified musical instruments and monitoring systems that can supply the performer with mobility, quality near-field cues, and pitch information while adding a minimum of complexity to the stage setup. A monitor system capable of providing quality near-field cues additionally can help protect musicians' ears from unneeded exposure to high sound pressure levels by obviating the perceived need to increase monitor volume.

### BRIEF SUMMARY OF THE INVENTION

An object of the invention is to meet the need for high quality, wide-frequency, personal monitoring of an electrical signal by a musician during the playing of an amplified instrument. A related object of the invention, required for its proper operation, is to reduce the microphonic susceptibility of an amplified musical instrument whereby acoustic energy on the surfaces of the instrument generates unwanted signals in the output of the instrument pickup.

The invention comprises an electromechanical emitting transducer located at an external surface of a musical instrument. An electronic acoustic signal to be monitored is applied to the input of this emitting transducer. The emitting transducer converts the electronic signal into acoustic energy, causing the exterior surface of the instrument to conductively transfer acoustic energy to a contacting exterior surface of the player's body where a bony structure of the head lies close to the surface of the skin. Bone conduction of acoustic energy through the player's skull to internal hearing organs then results in perception of the acoustic signal by the player. The invention advantageously requires no special earpieces, cords, or headsets, permits invisible, private monitoring, provides a frequency range wider than conventional monitoring devices, and is more sanitary and more convenient than personal monitors in the prior art. In the most preferred embodiment, the invention comprises a chin-supported instrument such as a violin or viola having as part of its chinrest an electromechanical emitting transducer for transfer of acoustic energy to the player's mandible.

### BRIEF DESCRIPTION OF DRAWINGS

FIG. 1 shows a top plan view of a first embodiment of the invention, comprising a complete musical instrument.

FIG. 2 shows a side view of a first embodiment of the invention, comprising a complete musical instrument.

FIG. 3 shows a side view in cross section through a conductively emitting surface, indicating the position of a player's mandible and skull during playing.

FIG. 4 shows an example of an electronic circuit for use with the invention.

FIG. 5 shows a back view of the invention, comprising a complete musical instrument.

FIG. 6 shows a cross sectional view through the waist at the bridge, perpendicular to the strings, of a conventional violin of the prior art.

FIG. 7 shows a cross sectional view through the waist at the bridge, perpendicular to the strings, of a conventional violin of the prior art with broken lines indicating computer-calculated deformations resulting from vibrational motion.

FIG. 8 shows a cross sectional view through the waist at the bridge, perpendicular to the strings, of a preferred embodiment of the invention.

FIG. 9 shows a cross sectional view through the waist, perpendicular to the strings, of a preferred embodiment showing a preferred pickup.

FIG. 10 shows a top view of a preferred pickup and its position relative to a bridge.

FIG. 11 shows a high frequency response curve of a preferred pickup.

### DETAILED DESCRIPTION OF INVENTION

There are at least two mechanisms by which we perceive sound. A first mechanism is by the action of air pressure variations, propagated through the air to the ear canal, and thereby to the eardrum, causing vibrations which are transferred from the eardrum to the ossicles, and eventually to the internal fluid and structures of the cochlea, causing the sensory phenomenon by which sound perception takes place. This air propagated hearing mechanism utilizes the structures of the outer, middle, and inner ear, and is normally the predominant means of hearing.

A second mechanism is bone conduction. In bone conduction, acoustic energy is conducted, principally by the bones of the jaw and skull, to the inner ear, bypassing the outer ear and, for the most part, the middle ear as well. Note that this acoustic energy conduction takes place without significant radiation of energy as sound into the air, and without perceptible motion of the structures through which the conduction takes place. The bones of the skull have been designed to serve as structural elements and not sound collectors, so bone conduction normally plays a minor role in hearing in the absence of an efficient coupling of acoustic energy to bones of the head. Bone conduction is nevertheless a well known phenomenon, used in diagnosis of conductive hearing disorders, and in some specialized technical areas. For example, bone conduction forms the basis of a device for a SCUBA diver's mouthpiece (May, U.S. Pat. Nos. 6,463,157 and 5,889,730 and 5,579,284, which are incorporated by reference). This device permits the diver to perceive speech underwater without need of an earpiece. Bone conduction is also the basis for at least one invention in which utensils, pens, toys or other handheld objects cause the perception of sound when inserted into the mouth (U.S. Pat. No. 6,115,477, incorporated herein by reference).

The phenomenon of acoustic energy conduction in rigid structures will be understood by analogy to the automobile mechanic's trick of placing one end of a rigid steel rod against a running engine, and the other end against some conductively receptive part of his head where bones of the skull lie near the surface of the skin. Acoustic energy within the engine block, indicative of an engine problem, is thereby made audible to the mechanic by bone conduction despite the air-conducted background noise made by the engine. In fact, if the mechanic plugs his ear canals while the steel rod is in contact with his head, he will actually perceive the engine noises more clearly, because his outer ears are not needed and only contribute air-conducted background noise. Note furthermore that the steel rod itself does not perceptively radiate sound, but merely conducts acoustic energy to the mechanic's skull. This conduction occurs despite little perceptible mechanical vibratory movement of the rigid rod itself.

In the most general embodiment, an electrical audio signal to be monitored drives an electromechanical emitting transducer located on an outer surface of a musical instrument. The electrical audio signal to be monitored preferably comprises signals from one or more pickups on the musical instrument, but may additionally or alternatively contain other signals containing musical accompaniment, click tracks, cues, or other information useful to the player. When the electromechanical emitting transducer is driven by the electrical audio signal to be monitored, the electrical audio signal is converted by the emitting transducer from electrical energy into acoustic energy. This acoustic energy is conducted from the electromechanical emitting transducer to the surface of the musical instrument, so that a conductively emitting surface is present on the instrument exterior. This conductively emitting surface is located on the musical instrument exterior at a place that contacts a conductively receptive external surface of the player's body, where a bony structure of the head lies close to the surface of the player's skin. Acoustic energy is then conducted from the conductively emitting surface, through the contacting skin of the player's body at the conductively receptive external body surface, to the underlying bony structure. Bone conduction of the acoustic energy through the player's skull then causes stimulation of the hearing organs, causing the player to perceive the audio signal without need of the acoustic energy being radiated into, or propagating through, the air. This general description of the invented monitoring device will be explained in more detail in the discussion of the preferred embodiment, below.

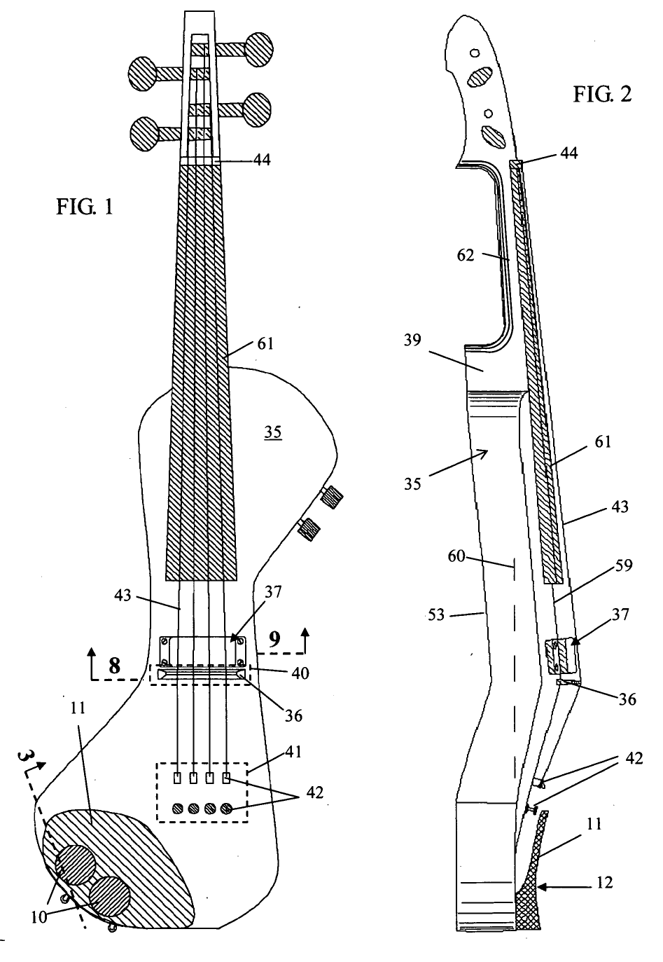

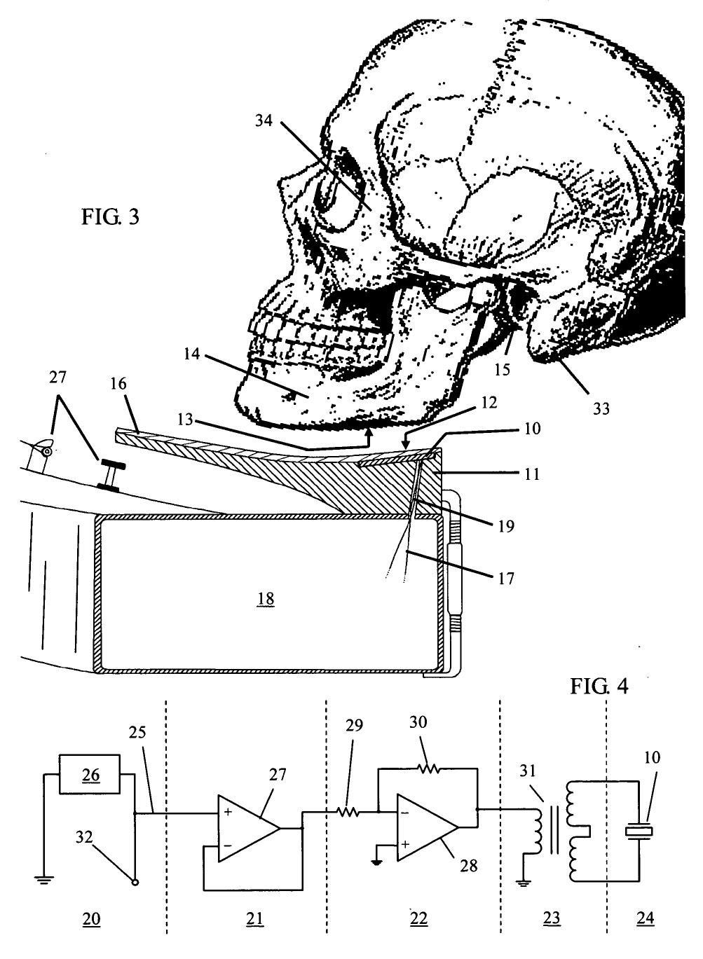

FIGS. 1 and 2 depict a preferred embodiment of the invention, in which the musical instrument is a chin-supported instrument such as a violin or viola. FIG. 1 shows two electromechanical emitting transducers (10) located on or in the instrument's chinrest (11), so that a contact surface of the chinrest comprises a conductively emitting surface (12). During playing (FIG. 3), the player supports the instrument under the chin, thereby pressing the skin overlying an anatomically inferior surface (13) of the mandible (14), into contact with the conductively emitting surface (12), resulting in bone conduction from the jawbone, or mandible (14), to bones of the skull near the hearing organs (15). The most preferred locations of the conductively emitting surfaces on the chinrest are shown by the emitting transducer positions (10) in FIG. 1, and are chosen to position the conductively emitting surface against the skin covering the inferior surface of the mandible. These preferred locations reflect the discovery that the skin over the inferior surface of the mandible is more conductively receptive than other surfaces of that structure. The term inferior is used here in the sense common in the anatomical nomenclature.

One suitable electromechanical emitting transducer (10) is a coin-shaped piezoceramic diaphragm of the type exemplified by Panasonic devices of the EFBS series (Panasonic Corporation, Secaucus, N.J.). Alternatively, other piezoelectric devices, such as piezoelectric film, could be used. Piezoelectric film devices have an advantage in being flexible and not as prone to breakage as are piezoceramic elements. However, any electromechanical actuator device capable of converting an electrical signal into acoustic energy, and disposing that energy at a conductively emitting exterior surface of an instrument for bone conducted monitoring, could be substituted without leaving the scope of the invention. In one preferred embodiment (FIG. 3), the electromechanical emitting transducer (10) is covered by a thin, sound conducting coating of resin, plastic, or other moisture and insulating barrier (16) so that the emitting transducer (10) is electrically isolated from the player's skin and protected from perspiration. In a preferred embodiment, the barrier layer (16) is a thin opaque black epoxy material that looks like a traditional chinrest surface, and thereby conceals the emitting transducer. Electrical leads (17) from the emitting transducer are conveniently routed to the instrument interior (18) for connection to a signal by means of a drilled passageway (19) passing through the chinrest (11).

The emitting transducer or transducers (10) may be inset into a matching cutout in a conventional wooden or plastic chinrest (11), or alternatively, molded integrally into a chinrest or instrument body formed of plastic, composite, cold-molded wood, or other material. The only requirement is that the electromechanical emitting transducers (10) convert the electrical acoustic signal into acoustic energy at the conductively emitting surface (12) for transfer to conductively receptive surfaces of the player's chin or jaw when the instrument is in its playing position. In one embodiment, the electromechanical emitting transducers are incorporated into a pad or cover that attaches to a conventional chinrest. This embodiment permits the monitoring device to be fitted to existing instruments.

Because piezoelectric elements have high impedance characteristics, when these devices comprise the electromechanical emitting transducers of the invention it is necessary to amplify the electrical signal to be monitored to provide a peak-to-peak amplitude of 10 to 30 volts or more. Buffering of the input signal is also desirable to prevent loss of tone of the amplified instrument by loading of the output of the string-sensing pickup. The buffering and amplification functions can be accomplished by a variety of electronic circuits, a simplified example of which is shown in FIG. 4. This circuit exemplifies the major signal processing steps (delineated by dashed lines in FIG. 4) in one preferred embodiment: an input stage (20); a buffer stage (21); a gain stage (22); an optional impedance matching stage (23); and an output stage (24). Specifically, FIG. 4 diagrams: an input stage (20) comprising an input (25) tapping an electrical signal source (26) to be monitored; a buffer stage (21) comprising a FET-input operational amplifier (27) configured as a unity gain voltage follower; a gain stage (22), comprising an amplifier (28) with a gain factor given by the ratio of a series resistor (29) and a feedback resistor (30); an optional impedance matching stage (23) comprising a step-up audio transformer (31); and an output stage (24) comprising a connection to an electromechanical emitting transducer (10). The operational amplifiers (27) and (28) shown in FIG. 4 require a bipolar power source, which may comprise two ordinary nine-volt transistor batteries (not shown). Note that the electrical signal source (26) may be connected to other devices in addition to the circuit of FIG. 4, so that the input of the circuit merely taps a line leading from the signal source (26) to another output terminal (32) or device.

Suitable components for use in the circuit of FIG. 4 with a line-level signal source (26) are FET-input operational amplifiers such as the TL084 or LM741, a series resistor (29) value of 1 K ohms, a feedback resistor (30) value of 10K ohms, an audio output transformer (31) equivalent to model EI-19 (Mouser), and a piezoceramic diaphragm (10) equivalent to part number EBFS66D01 (Panasonic). However, a person having ordinary skill in the electronics art will recognize that FIG. 4 represents only a sketch of basic functions (buffering, voltage amplification, and impedance matching), and that many variations exist on piezoelectric driver circuits of this type, including the addition or substitution of parts to provide balanced inputs, push-pull outputs, multiple gain stages, filtering stages, effects blocks, improved power supply or stage isolation, and noise immunity, power switches, volume, tone, or EQ controls, and power or level indicators. A person having ordinary skill in the electronics art will further recognize that this circuitry could be built into a musical instrument, attached to a musical instrument, worn on a belt, incorporated into an outboard rack or amplifier, interfaced to wireless devices or digital audio systems, or otherwise packaged. None of these modifications would depart from the intended scope of the invention.

Other embodiments of the active monitoring invention can make use of alternative conductively receptive exterior body surfaces for coupling of acoustic energy to the player's skull structures. This can be done by addition of projections on a chinrest or instrument that contact skin overlying bony structures of the skull (FIG. 3), such as the player's mastoid process (33), where these are near the surface of the skin. In this manner, the player-to-instrument contact point can be changed, or the transfer of energy to the mandible augmented. In embodiments of the active monitoring invention on or in non chin-supported instruments, coupling locations other than the chin and jaw may be preferred. The mastoid process (33) is particularly attractive as a coupling site because it is close to the skin and located conveniently near the hearing organs (15) and so offers efficient bone conduction thereto. The mastoid process is preferred therefore for bone conduction monitoring of violincellos or basses using the invention. On these instruments, a conductively emitting surface can be located preferably on a projection near the the scroll of an instrument so that contact with a player's mastoid process may be achieved by a simple incline of the player's head toward the scroll while playing. The skull bones at the player's temple (34) comprise another useful conductively receptive surface.

The invention should be contrasted from any natural passive bone conduction and perception that may take place normally during the playing of an acoustic chin-supported instrument such as the violin, as acoustic energy is incidentally conducted from the strings to the bridge, body and possibly to the chinrest and player. Firstly, this passively bone conducted sound is largely obscured by the much louder near field sound radiated from the soundboards of an acoustic instrument and, when an amplified instrument is played, the ambient air-conducted sound in typical performance environments. In contrast, the invention provides electronically amplified bone conducted perception of the monitored signal at levels that are much more useful to the performer. Secondly, the invention permits monitoring of signal characteristics not possible by any natural passive bone conduction process, including very high frequency cues that are sensed by the instrument pickups but attenuated or not present in the normal near field sound. The invention also permits monitoring effects such as distortion, reverberation, delays, and other intentional manipulations of the signal which can only be monitored by electronic means. The invention additionally provides for monitoring of external electronic signals such as click tracks, timing cues, vocals, or other instruments.

At least six important advantages of the invention make it desirable over the prior art. Firstly, while the range of frequencies that may be monitored by air conductive hearing are limited by the frequency response of the outer and middle ear structures, the attenuation of intervening air, and the frequency response of earphone or speaker systems, a much wider range of frequencies may be perceived by bone conduction. There is evidence that bone-conducted ultrasonic cues improve speech discrimination in humans (Lenhardt, et al, 1991, Science 253:, 82-85, and U.S. Pat. No. 6,731,769, incorporated herein by reference) and it is likely that similar cues are used by highly trained violinists. In fact, the highest harmonics of the violin extend into the ultrasonic range (>40 kilohertz) and these frequencies may be perceived by bone conduction (Ernst, 1945, J. Sci Instrum. 22, 238-243).

Secondly, bone conduction is accomplished in the invention without the free radiation of acoustic energy as sound, so that the monitoring experience of the user of the invention is private: the monitored cues are inaudible to other performers, bystanders or to the audience. The invention thereby not only simulates the ideal of separate near-field and far-field sounds previously attainable only with acoustic instruments, but furthermore allows the player to privately tune his strings, warm up, or practice without emitting significant audible sound that might disrupt a performance, distract an audience, or disturb a sleeping spouse. External electrical acoustic signals may be utilized with the bone conduction monitor, enabling a performer to play along with a click track, metronome, or musical accompaniment for practice or recording purposes, the click track or accompaniment being inaudible to anyone but the performer if desired.

Thirdly, the invention requires no special headpieces or devices that must be put on prior to use as do other bone conduction headsets in the art (see for example U.S. Pat. Nos. 6,885,753 and 7,076,077, incorporated herein by reference). Fourthly, the invention prevents the sanitary problems common to conventional ear-bud monitors which are placed in the ear canal, and bone conduction devices of the prior art that must be placed within the mouth (Filo, et al. U.S. Pat. No. 6,115,477, incorporated herein by reference). To use the invention, the musician need merely support the instrument under the chin in the normal manner to perceive the monitored signal. A fifth advantage of convenience is thereby realized. A final advantage is that the invention is practically invisible to the audience and makes almost no change to the instrument's aesthetic appearance.

The bone conduction monitoring device described so far may be used with ordinary chin supported stringed instruments, but performs even more satisfactorily if the instrument design is optimized to prevent of leakage of amplified acoustic energy from the electromechanical emitting transducer to the body and bridge or strings, so as to generate a signal in the instrument's pickup output. If this occurs, it can cause the same problems already described in connection with microphonics: feedback, poor channel isolation, and noise artifacts. One method of preventing leakage of acoustic energy into the instrument output is to provide an energy absorbing barrier between the electromechanical emitting transducer and the rest of the instrument. This can be done by inserting resilient materials between the emitting transducers and the chinrest, between the chinrest and the instrument body, or, depending on the location of the pickups, between the body and bridge or between the body and transducer. In fact, violin and viola chinrests are normally mounted on a resilient cork or leather pad to avoid damage to the instrument surface. However, the most preferred embodiment is to prevent leaked acoustic energy from being sensed by the pickups by means of other instrument modifications that also provide the benefit of reduced microphonic susceptibility, as discussed below.

FIGS. 1 and 2 show a preferred microphonic-resistant embodiment of the invention as a complete chin-supported instrument comprising: a conductively emitting surface (12) located on a chinrest (11); a body (35); a bridge (36); and a pickup (37) that together reduce microphonic sensitivity and susceptibility to acoustic energy leakage from the conductively emitting surfaces (12). This preferred embodiment also provides reduced weight compared to conventional amplified chin-supported instruments.

The instrument body (35) is fabricated from composite laminates. Composite laminates and techniques for their construction are well known, being widely employed in the manufacture of parts in the automotive, aircraft, and boat industries where strength, rigidity and light weight are demanded. Composite laminates are formed by mixing reinforcing fibers with a minimum amount of liquid resin, the resulting matrix being shaped into the desired part by a mold, form, or pattern. When hardened, the resin binds to the fibers and supports them dimensionally to form a solid structure. The properties of the resin are relatively unimportant beyond its role as a binder: the properties of the composite so formed (tensile strength, coefficient of expansion, etc.) are dictated primarily by the type and orientation of fibers in the structure. By selection of the type, amount, and orientation of fibers, a composite part may be designed to have maximum strength along the axes through which it will bear load, while minimizing weight elsewhere. This weight minimization is not possible in bodies molded from homogeneous polymers lacking fibers (U.S. Pat. No. 4,144,793 which is incorporated herein by reference).

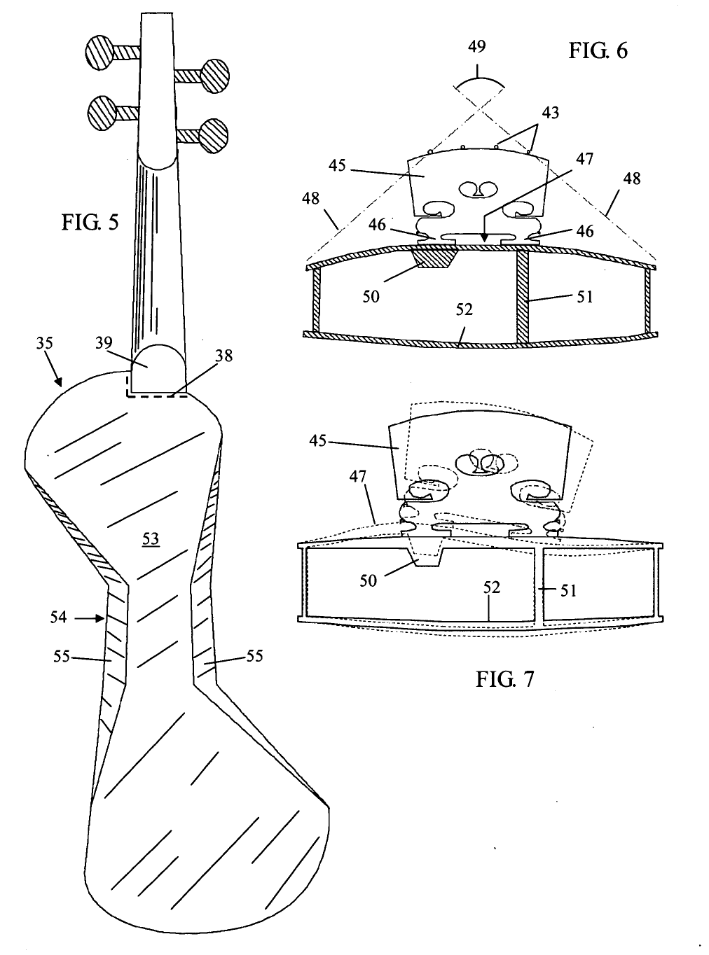

The instrument body (35), shown in top plan view in FIG. 1, in side view in FIG. 2, and in back plan view in FIG. 5 is constructed in two halves in a female mold by the “wet layup” method, which is described in the literature and need not be related in detail here. The female mold may be thought of as a “cake pan” having a smooth-finished, open cavity that defines the shape of the finished instrument body. To manufacture the invention's body, the mold is first coated with parting agent to prevent the finished body from sticking to the mold surface. Catalyzed resin is then brushed onto the mold surface and allowed to partially harden, forming a clear film that will eventually give the part a glossy finish. Finally, the actual composite lamination is formed by placing layers of reinforcing fiber material into contact with the mold surface, filling the space between the fibers with resin. When all laminates are in place, the resin is allowed to harden, and the body half is removed from the mold. Two complementary halves are then joined using an adhesive to form a complete body (35) that is a hollow structural shell. The female mold is reused to produce duplicate parts in a cycle that lends itself to rapid manufacture, but individuals skilled in the art of composite construction will also appreciate that many other techniques may be used to construct a similar instrument body using composites, including male molds, plugless construction, vacuum forming, vacuum bagging, and the like.

An advantage to the female mold method of construction is that an instrument body (35) is constructed from the outside in. Reinforcing fibers may therefore be invisibly be applied during the construction process in positions and orientations as required to strengthen critical load bearing areas of the body, creating load-bearing pads (FIGS. 1 and 2). These pads comprise a neck attachment pad (38) in the body's side, where a neck heel (39) joins the body (35), a bridge support pad (40), where the bridge (36) rests on the body (35), and a string securement pad (41) where fine tuners (42) mount in the body (35). In particular, the body is shaped and constructed so that reinforcing fibers under the strings (43) are positioned as close as possible to, and as parallel as possible to, the segments of the strings extending from the nut (44) to the bridge (36) and from the bridge to the fine tuners (42) or string securement pad (41). This adjacent and parallel disposition of the strings and reinforcing fibers applied the tension of the strings axially to the reinforcing fibers.

Davis, et al describe a hollow shell body of composite construction (U.S. Pat. No. 6,683,236, which is incorporated herein by reference) but their invention is a unitary structure, molded in one piece, not formed in two halves, and is directed at providing superior acoustic radiation. The unitary body of Davis, et al. would therefore be more susceptible to microphonics than the body of the present invention. Peavey (U.S. Pat. No. 4,290,336, incorporated herein by reference) teaches a two-piece molded guitar body, but Peavey's invention requires the presence of internal ribs and at least some foam inserts to control body resonances. The body of the present invention requires neither ribs, cores, inserts, or foam dampeners. It also does not require elastomeric internal layers, as used in other composite body inventions (Verd, U.S. Pat. No. 4,290,336, incorporated herein by reference). It is advantageous not to have foam, ribs, a core, or other obstructions internal to the body, since these mechanically obstruct the installation of internal wiring, controls, active electronics, and other internal parts.

A preferred embodiment of the invention utilizes a molded body (35) fabricated by successive addition to the mold of the following layers:

1. two brushed coats of clear catalyzed epoxy resin (West System 105/207);

2. a wet layup of resin (West System 105/206) and either two (instrument back) or three (instrument top) layers of bi-directional carbon fiber cloth (2.9 oz/square yard) with the fibers orientation changed 45 degrees with each successive layer;

3. reinforcement of the neck attachment pad (38), the bridge support pad (40), and the string securement pad (41), (2.9 oz/square yard bi-directional carbon); and

4. an optional final single inner layer of fiberglass cloth (3 oz/sq yd). All composite materials were obtained from Composite Structures Technology (Tehachapi, Calif.).

The finished thickness of the composite body walls created in this manner varies from 1.3 millimeters to 2.5 millimeters (0.050 to 0.100 inch). In the preferred embodiment, carbon fiber is used as the primary reinforcement because its tensile strength is comparable to that of steel but with less than one fourth the comparable mass. Carbon fiber has a modulus ten times that of wood fibers and advantageously provides strength, low weight, and dimensional stability during handling and changes in ambient temperature and relative humidity. However, one skilled in the art of composite design and construction will recognize that other materials, reinforcing weaves, fibers, and resins might be substituted or combined to construct the invention. Possible alternatives include glass, Kevlar®, Kevlar/Carbon mixes, unidirectional fiber, bidirectional weave, crowfoot, chopped mat, chopped fiber, pre-peg, fillers, epoxies, and polyester resins.

While the use of composite materials can produce an instrument body of high strength to weight ratio, use of these materials alone does not ensure that the body will not vibrate in use. Evidence for this fact is found in inventions that use carbon fiber composites in the construction of soundboards for guitars and violins in which these composite materials serve in the conventional way as acoustically vibrating and radiating plates of an instrument's body. In fact, a specific goal of much prior art using composites for instrument bodies is the duplication (U.S. Pat. No. 4,873,907, incorporated herein by reference) or enhancement (U.S. Pat. No. 4,408,516, U.S. Pat No. 4,955,274, and U.S. Pat. No. 6,284,957, incorporated herein by reference) of the mechanical and acoustic properties of wood as a soundboard material. Others have sought these acoustic properties by combining composite laminates with cellulose or other core materials (U.S. Pat. No. 4,364,990, incorporated by reference), by varying the thickness and reinforcement orientation (U.S. Pat. No. 6,737,568, incorporated by reference), or by varying the area (U.S. Pat. No. 6,610,915, incorporated by reference) of the composite body plates. Composite materials are also used in the bodies and necks of amplified violins built by Design & Harmonie (Place de l'Hôtel de Ville, 32230 Marciac, France), but these instruments also utilize composite soundboard plates specifically designed for acoustic resonance (U.S. Pat. No. 5,171,926, incorporated by reference). These composite-bodied instruments of the prior art also do not incorporate the invention's vibration-resistant body shape, which is discussed below. Rather these composite-built instruments retain a conventional outer body cross section at the bridge similar to FIG. 6, which is undesirably susceptible to microphonics and leakage of acoustic energy when used with the invention.

FIG. 6 shows a cross section through the waist of a violin design of a type common in the prior art, looking toward the neck of the instrument. The carved wooden bridge (45) rests on two feet (46) and supports the strings (43) about 3.6 cm above the surface of the soundboard, or top (47). The dotted lines in FIG. 6 (48) indicate the limiting clearance angle (49) at which a bow may be drawn across the two outer strings without the bow rubbing on the soundboard. This angle is approximately 97 degrees in traditional acoustic violins, but varies from maker to maker. A computer generated analysis of the deformation of this structure in response to string vibrations (FIG. 7) demonstrates how vibration of the strings causes the bridge (45) to rock (broken lines) relative to its resting position (solid lines) in a plane perpendicular to the strings, transferring this dynamic string motion via the bridge feet to the soundboard (47), which flexes, these dynamic motions being transferred throughout the soundboard by a bass bar (50) and, via a sound post (51), to the instrument back (52). (The degree of this motion is exaggerated in FIG. 7 for illustrative purposes.) Sound is radiated into the air by the resultant mechanical motions of the soundboard and back. This transfer of dynamic string motion to the bridge and body surfaces in conventional violins and violas tends to damp the string vibration, reducing sustain, as vibrational energy is drawn from the strings to the vibrating plates of the instrument body. This mechanical coupling between motion of the soundboard and back to motion of the strings is desirable in an acoustic violin, but is very undesirable in amplified instruments because of the resulting microphonic susceptibility it causes in amplified instruments utilizing the cross section of FIG. 6.

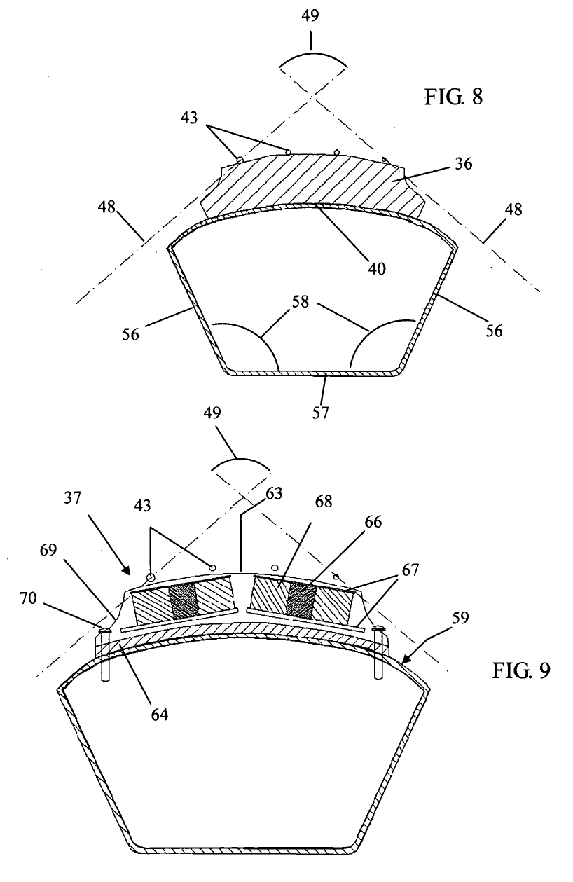

The body shape of the preferred embodiment (FIG. 5) has a back surface (53) narrower than the top surface at the instrument's waist (54), so that the body sides (55) are not parallel at the waist. FIG. 8 shows a cross sectional view through the waist of the body of the invention at the bridge support pad (40). The cross section of the body shell is substantially an isosceles trapezoid having two sides (56), a shorter base (57), and a longer base. The longer base of the trapezoid is outwardly convex and forms the bridge support pad (40) upon which the bridge (36) rests. Preloaded by the pressure of the strings (43), this trapezoidal cross section is extremely resistant to bridge rocking, because the rocking force is applied axially along reinforcing fibers of the instrument sides (56) so long as the internal angles (58) between the shorter base and sides are at least 110 degrees or more in cross section through the bridge support pad.

The convexity of the bridge support pad (40) improves bow clearance but also applies the string pressure more axially to the reinforcing fibers in the bridge support pad, making the structure highly resistant to sagging under the string pressure. Comparison of FIGS. 6 and 8 shows that the bridge (36) in the invention is modified relative to the conventional instrument by reducing its height to support the strings (43) no more than 17.8 millimeters (0.7 inch) above the top of the bridge support pad (40). The reduced height of the bridge (36) shortens the lever arm whereby string motion is transferred to the instrument body top, further hindering the motion of the strings from causing rocking deformations that would lead to vibration of the body shell. The feet of the conventional bridge (46) have also been removed in the invention, and the bridge base made wider and curved to match the radius of the bridge support pad, so that the contact area of the bridge (36) with the bridge support pad (40) is increased from 100 square millimeters (typical) in the conventional violin to at least 250 square millimeters in the invention.

The trapezoidal cross section, the increased bridge-to-top contact area, the curvature of the bridge base, the shorter bridge lever arm, the position of the bridge (36) directly over the bridge support pad (40), and the substitution of axially loaded carbon reinforcement fibers, having a modulus ten times that of wood fibers, all act in combination to stabilize the assembly against mechanical rocking motions induced by the strings' vibration. These elements in combination are responsible for the invention's superior microphonic resistance and reduced susceptibility to leakage of acoustic energy from electromechanical emitting transducers in the chinrest assembly.

Computer analysis of the structure shown in FIG. 8 determines that the modifications yield a more than tenfold reduction in the deformation of the body surfaces under the conditions of string vibration modeled in FIG. 7, and the resulting microphonic resistance is borne out in the actual instrument. The reduced vibrational coupling from the strings to the body causes a desirable increase in the invention's “sustain” (the length of time a note continues to reverberate after playing). In one embodiment of the invention, the bridge (36) is machined from metal (brass or less preferably, aluminum) so that its mass further impedes transfer of vibrations to the body. However, use of a metal bridge adds undesirable weight to the invention, and the most preferred embodiment utilizes a bridge made from a plastic or composite laminate. Note by the dotted lines (48) in FIG. 8 that the invention's body cross section maintains a clearance angle (49) of approximately 97 degrees, preserving the playability of the conventional instrument.

FIG. 2 shows that the use of a bridge of reduced height (36) allows the upper body surface (59) of the invention to be closer to, and more parallel to, the plane of the strings (43) so that the reinforcing fibers of the composite laminate are more parallel to, and closer to, the strings than would be possible in the top of a conventionally-shaped instrument, the height of which is indicated by the broken line (60). In the preferred embodiment, the strings are at no point greater than 17.8 millimeters (0.7 inch) away from the top of the composite body shell. Axially loading the reinforcing fibers in this way leads to maximum strength and rigidity, allowing reduced weight while retaining tuning stability, and permitting the conventional tailpiece to be eliminated with a savings in weight and complexity. In the embodiment shown in FIG. 1, the string ends terminate directly in the integral string securement pad (41), or in conventional fine tuner devices (42) mounted in the string securement pad (41). Besides eliminating weight this arrangement applies the combined string tension directly to the body shell, preloading the composite fibers and raising the resonant frequency of the lower bout area of the body shell, which is already higher than a conventional instrument body, reducing the likelihood of microphonics.

Vibrational motion of the body is further reduced by the supporting shape of the instrument back (53), which is also substantially parallel to the strings (43), and by the fingerboard (61), which need no longer be suspended over the body as is done in traditional instruments to avoid damping vibration of the top plate. Instead, the fingerboard (61) is bonded to the neck (62) and body (35) directly, lending additional mechanical strength and rigidity. It should be noted that at least since 1938, amplified violins in the prior art have occasionally incorporated a body top somewhat parallel to the strings (U.S. Pat. No. 2,130,174 incorporated herein by reference, compare also the more recent instruments produced by Jensen Musical Instruments, Seattle, Wash.), and bridges of reduced height. However the instruments of the prior art lack the combined advantages of composite construction and the trapezoidal cross section that in combination suppress microphonics while permitting the use of a hollow body shell with savings in weight.

Overall weight of the finished body of a four-string violin embodiment of the invention is 454 grams (16 ounces), including a maple neck and ebony fingerboard. Fully assembled, with shoulder rest, chin rest, pegs, bridge, strings, transducer, and controls installed, the final weight of the instrument is typically 709 to 794 grams (25 to 28 ounces) but never more than 850 grams (30 ounces), not including the bow. For comparison, one standard full-sized violin with attached shoulder rest was found to weigh 567 grams (20 ounces) as played, and a compilation of Guarneri del Gesu violin data reported an average weight for these fine instruments of 510 grams (18 ounces) allowing for shoulder rest and chinrest weights of 57 grams (2 ounces) each. By contrast, a commercial amplified violin by Fender resembling the drawings in U.S. Pat. No. 3,003,382 (incorporated by reference) weighs 2.2 kilograms (80 ounces), while the lightest professional amplified instruments for which data is available, manufactured by Guscott Violins (Queensland, Australia), approach 765 grams (27 ounces) (Matera, J., Australian Musician, 35: 2003) but lack the benefits of the invention. More typical weights for commercial amplified violins are between 992 and 1,417 grams (35 and 50 ounces).

The features of the preferred instrument body described above reduce to a great degree the susceptibility of the invention to acoustic energy leakage. Further reduction of this susceptibility is obtained by the preferred pickup device (37). Pickups which sense acoustic energy at the point of contact between the strings and bridge (McClish, U.S. Pat. No. 4,903,566, incorporated herein by reference) or between the bridge and body (U.S. Pat. Nos. 3,003,382, and 1,861,717, incorporated herein by reference) are particularly susceptible to infinitesimal displacements of the sensed parts and are therefore more sensitive to leakage of acoustic energy from the conductively emitting surfaces (12) of the invention.

FIG. 9 shows a cross section through the waist of the invention at the pickup looking toward the neck. The preferred embodiment includes a low-profile electromagnetic pickup (37) with a curved shape matching substantially that of the body surface (59) upon which the pickup mounts. The reduced bridge height requires that the curved top surface of the pickup assembly (63) extend radially in height no more than about 12.7 millimeters (0.5 inch) above the mounting surface. The pickup is, for reasons of simplicity and mechanical stability, mounted directly on the instrument body top (59), or on a compressible shim (64) that serves to adjust the vertical height of the pickup and provides isolation from leaked acoustic energy. The top surface of the pickup (64) is adjusted to be in close proximity to the strings (43) but at a sufficient distance that the strings do not contact the pickup during playing. The pickup, being of the electromagnetic type, is sensitive only to relative motion of the magnetically permeable strings and pickup assembly, and is therefore less sensitive than piezoelectric pickups to the infinitesimal movements of nonmagnetic parts of the instrument caused by leaked acoustic energy.

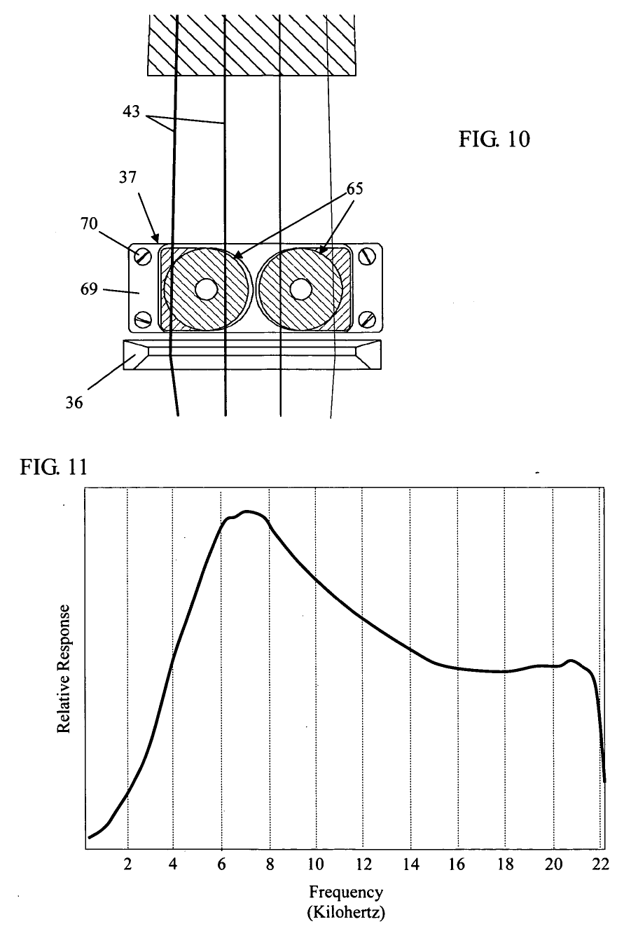

Referring to FIG. 10, the preferred location of the pickup (37) is very near the bridge (36). This location provides more high frequency cues in the pickup output, and importantly avoids detection of dissonant string vibrations arising from the partial stopping of the string by the bow hair during playing. This very objectionable artifact is inevitably present in the output of electromagnetic pickups for bowed instruments in the prior art (Bowtronics, 1238 William St, Pt. Pleasant, N.J., see also U.S. Pat. No. 2,130,174 FIGS. 1 and 2) that sense vibrational movement of the string segment bounded by the instrument's nut (44), or player's left hand fingers where these stop the string, and the point where the bow hair contacts the string. This string segment, being of length similar to, but uncontrollably different from, the musically important string segment bounded by the nut and bridge produces during playing with a bow a pitch that is close to, but uncontrollably different from, the desired musical pitch. The undesirable pitch is uncontrollable because the position of the contact point between the bow hair and the string is not normally influential of pitch and so is not controlled precisely by the player.

Referring to FIG. 10, the preferred pickup (37) has a width, measured along the string, of 20 millimeters (0.8 inch) and is mounted directly against the bridge (36) or spaced away from it by no more than 3.2 millimeters (0.125 inch) so that a significant portion of the bow hair contact point is directly over the pickup during sul ponticello playing, when the bow contact point is near the bridge. At all other times, the pickup senses the string between the bow hair contact point and bridge.

Another advantage of this pickup placement is that it is incapable of detecting the undesirable “wolf note” vibrations of the string segments between the string's termination at the fine tuners and the string's contact point with the bridge. Pickups that sense body or bridge motion, or movement of the strings at the bridge contact points, all are susceptible to sensing sympathetic wolf note vibrations.

The preferred pickup design (FIGS. 9 and 10) comprises two coil assemblies (65), each comprising a neodymium NdFeB permanent magnet rod (66) (All Magnetics, Anaheim, Calif.) having a diameter of 4.77 millimeters (0.188 inch) and a length of 6.35 millimeters (0.25 inch). NdFeB is preferred as a magnetic material because its magnetic flux/volume ratio is significantly higher than the Alnico or ceramic magnets more commonly employed in pickup construction, thereby allowing the invention's pickup to be made lower in profile while retaining high magnetic power and signal output. The pole faces of each magnet are attached to discs of insulating sheet material (67), forming a bobbin upon which is wound a coil of magnet wire (68) (Essex Brownell, Tempe Ariz.) using the same techniques and equipment employed to fabricate guitar pickups. Each coil assembly is positioned midway between two strings (43), so that two coils together sense the motion of four strings.

Because the strings at the bridge of a bowed instrument do not lie in a plane, the magnetic rods (66) and coils (68) thereon must be tilted so that the long axis of the magnets lie perpendicular to a plane containing the two strings sensed by that coil, as shown in FIG. 9. For a violin, the coil assemblies are tilted about ten degrees from the vertical axis of FIG. 9. The coil assemblies are shielded with copper foil and potted in epoxy within a vacuum formed plastic cover (69) to prevent microphonic noise in the pickup output caused by vibration of the internal parts of the pickup. The cover (69) is normally opaque but is shown transparent in FIG. 10 for clarity. The copper shielding foil is also not shown in FIGS. 9 or 10 for clarity. The two coil assemblies are connected in humbucking configuration to reject electromagnetic interference. This humbucking configuration, as well as the details of potting, shielding, and coil winding are well known to individuals skilled in the art of pickup construction.

Importantly, the preferred pickup has a number of windings chosen to provide a self-resonance located at or above 7 kilohertz so that very high frequency cues are enhanced in the pickup output for use with the bone-conduction monitor. In one preferred embodiment, 9000 turns of 43 AWG magnet wire is used, resulting in the high frequency response shown in FIG. 11. The pickup has increasing output responsiveness at frequencies above 4 kilohertz, a resonance peak of maximal response between 6 and 8 kilohertz, and significantly flat response at frequencies higher than 10 kilohertz. The drop-off in response above 20 kilohertz shown in FIG. 11 is an aliasing artifact of the measuring equipment used to measure the pickup's response, and serves to illustrate that the pickup is responsive to frequencies higher than can be detected by typical audio test equipment. When used with the bone conduction monitoring system, the preferred pickup measurably provides the very high frequency cues desirable for monitoring.

The pickup is sensitive to motion of nearby magnetic objects, and for this reason all pickup mounting hardware is non-magnetic in order to prevent vibrations of these parts creating microphonic signals in the pickup output during playing. In the preferred mounting method (FIGS. 9 and 10), the pickup is held in place using plastic machine screws (70) passing through holes tapped into the instrument body. Note (FIG. 9) that the dimensions of the pickup assembly preserve a clearance angle (49) very near that of a conventional violin.

A variety of electromagnetic pickup designs could be used with the invention, and one skilled in the art of pickup design will recognize that all such devices basically comprise one or more permanent magnets and one or more coils of fine wire. The reader will appreciate that the specific embodiment of the invention disclosed here, though preferred, is but one possible method of executing its construction. Other forms of pickup which do not require physical contact with a vibrating string would also be suitable for use with the invention, including pickups making use of optical, capacitive, or electrostatic motion detection. In other embodiments of the invention, the bridge and transducer are attached or are a single integral part. The invention is also applicable with minor modifications to instruments having more than the traditional four strings, or strings of different gauges, such as the baritone violin. None of these modifications, substitutions or changes would depart from the scope of the invention, which is set forth in the claims below. The scope of the invention should, therefore, be determined not with reference to the above description, but instead should be determined with reference to the appended claims along with their full scope of equivalents.

In summary, the invention is an active electronic monitoring device for musical instruments that affords the musician enhanced perception of acoustic cues during playing by means of electronic amplification and bone conduction from an electromechanically-driven conductively emitting surface to a conductively receptive body surface at the normal contact points between the instrument and the player's body. This device is especially suited to use with the chinrest of chin-supported instruments. The invention advantageously requires no special earpieces, cords, or headsets, permits invisible, private monitoring, provides a frequency range wider than conventional monitoring systems, and is more sanitary and more convenient than conventional personal monitoring systems in the prior art. In the most preferred embodiment, the invention is fully integrated into a lightweight chin-supported musical instrument having a body shape and pickup design that in combination facilitate high frequency cues in the monitored signal while resisting microphonics and leakage of acoustic energy from the monitoring system into the instrument output.

I claim:

1. A bone conduction monitoring device for use by the player of a musical instrument, said monitoring device comprising:
(a) at least one conductively emitting surface located on the exterior of a musical instrument, said conductively emitting surface comprising an electromechanical emitting transducer;
(b) said conductively emitting surface contacting a conductively receptive exterior surface of the player's body, said conductively receptive exterior surface comprising skin adjacent to a skeletal structure of the player's head; and
(c) an electrical connection between said electromechanical emitting transducer and an electrical audio signal to be monitored.

2. The monitoring device of claim 1, wherein:
(a) said musical instrument is an electric musical instrument further including at least one pickup receptive of musical vibrations of the instrument; and
(b) said electrical audio signal to be monitored comprises an electrical audio signal derived from said pickup.

3. The monitoring device of claim 1 wherein said electromechanical emitting transducer comprises a piezoelectric device and said electrical connection comprises a voltage amplifier.

4. The monitoring device of claim 1, wherein:
(a) said musical instrument comprises a chin supported stringed instrument; and
(b) said conductively receptive exterior surface of said player's body comprises skin covering said player's mandible.

5. The monitoring device of claim 1, wherein:
(a) said musical instrument comprises a chin supported stringed instrument, equipped with a chinrest;
(b) said conductively emitting surface comprises a portion of the surface of said chinrest; and
(c) said conductively receptive exterior surface of said player's body comprises skin covering said player's mandible bone.

6. The monitoring device of claim 1, wherein said conductively emitting surface comprises a projection extending from said musical instrument and said conductively receptive exterior surface of said player's body comprises skin covering said player's mastoid process.

7. A musical instrument, comprising:
(a) an exterior portion in contact with a conductively receptive exterior surface of a player's body;
(b) said conductively receptive exterior surface comprising skin covering a skeletal structure of said player's head;
(c) said exterior portion comprising at least one conductively emitting surface;
(d) each said conductively emitting surface comprising at least one electromechanical emitting transducer; and
(e) an electrical. connection between an electrical audio signal to be monitored and an electrical input of a said electromechanical emitting transducer.

8. The musical instrument of claim 7, wherein:
(a) said musical instrument comprises an electric musical instrument equipped with a sensing transducer responsive to musical vibrations originating from said electric musical instrument, and generating an electrical instrument signal therefrom;
(b) said electrical audio signal to be monitored comprises said electrical instrument signal; and
(c) said electrical connection comprises a voltage amplifier.

9. The musical instrument of claim 7 wherein:
(a) said musical instrument comprises a stringed instrument that is held under said player's chin;
(b) said musical instrument further comprises a chinrest;
(c) said exterior portion of said instrument comprises the chinrest of said instrument; and
(d) said conductively receptive exterior body surface comprises skin covering said player's mandible.

10. The musical instrument of claim 7 wherein said electromechanical emitting transducer comprises a piezoelectric device.

11. The musical instrument of claim 10 wherein:
(a) said musical instrument comprises a stringed musical instrument held under said player's chin;
(b) said conductively receptive exterior body surface comprises skin covering said player's mandible;
(c) said musical vibrations comprise motions of the instrument's strings;
(d) said sensing transducer comprises an electromagnetic pickup responsive to said string motion; and
(e) the strings of said instrument are magnetically permeable.

12. A chin supported stringed musical instrument comprising:
(a) a hollow body shell of molded epoxy composite, comprising a bridge support pad and a string securement pad;
(b) a chinrest attached to said body shell;
(c) a neck comprising a first end adapted to secure one or more strings, and a second end attached to said body shell;
(d) one or more magnetically permeable strings, secured at said first end of the neck and at said string securement pad, said strings extending over said body shell;
(e) a bridge, resting on said bridge support pad and supporting said strings not more than 17.8 millimeters from said bridge support pad;
(f) an electromagnetic pickup responsive to vibrations of said strings, attached to the surface of said body shell, projecting no more than 12.7 millimeters from said surface of said body shell, and spaced apart from said bridge by not more than 6.4 millimeters; and
(g) a body cross sectional shape through the plane of said bridge that is substantially a trapezoid having two sides, a short base, and a long base,
(i) said short base meeting the sides with interior base to side angles greater than 110 degrees,
(ii) said long base having outward convexity and comprising said bridge support pad.

13. The instrument of claim 12 wherein said electromagnetic pickup has a response maximum between 5 kilohertz and 9 kilohertz, and further comprises at least two coil assemblies, each said coil assembly disposed adjacent to two said magnetically permeable strings, each coil assembly comprising:
(a) a neodymium permanent magnet rod, said rod having a longitudinal length of not more than 6.4 millimeters and a diameter of not more than 5 millimeters; and
(b) a coil of wire exceeding 5000 turns encircling said rod.

14. The instrument of claim 13 wherein the longitudinal axis of each said neodymium permanent magnet rod is tilted so that said axis of said rod is substantially perpendicular to a plane containing the two said magnetically permeable strings disposed adjacent to said rod.

15. The instrument of claim 12 further comprising:
(a) an exterior portion in contact with a conductively receptive exterior surface of a player's body;
(b) said conductively receptive exterior surface comprising skin covering a skeletal structure of said player's head;
(c) said exterior portion comprising at least one conductively emitting surface;
(d) each said conductively emitting surface comprising at least one electromechanical emitting transducer; and
(e) an electrical connection between an electrical audio signal to be monitored and an electrical input of a said electromechanical emitting transducer.

16. The instrument of claim 15 wherein:
(a) said exterior portion comprises said chinrest;
(b) said at least one conductively emitting surface comprises a portion of the surface of said chinrest; and
(c) said conductively receptive exterior surface of said player's body further comprises skin covering the inferior surface of said player's mandible.
